(19) United States
(12) Patent Application Publication
(10) Pub. No.: US 2012/0006360 A1
(43) Pub. Date: Jan. 12, 2012

(54) METHOD FOR OPERATING A WATER CONDUCTING HOUSEHOLD DEVICE

(75) Inventor: Michael Georg Rosenbauer, Reimlingen (DE)

(73) Assignee: BSH BOSCH UND SIEMENS HAUSGERÄTE GMBH, Munich (DE)

(21) Appl. No.: 13/256,442

(22) PCT Filed: Mar. 16, 2010
(86) PCT No.: PCT/EP2010/053354

§ 371 Date: Sep. 14, 2011

(30) Foreign Application Priority Data
Apr. 2, 2009 (DE) 10 2009 002 150.7

(51) Int. Cl. A47L 15/46; B08B 3/00; A47L 15/00; A47L 15/42

(52) U.S. Cl. 134/18; 134/56 D

(57) ABSTRACT

In a method for operating a water-conducting household device a level of filter contamination of a filtration system connected in a hydraulic circuit of the household device is determined. When detected that a predetermined threshold level of filter contamination has been undershot, wash liquid is partially discharged out of the household device.

The invention relates to a method for operating a water-conducting household device as claimed in the preamble of claim 1.

Reduced water consumption is very important in water-conducting household devices such as, say, a dishwashing machine.

In such a generic dishwashing machine a wash cycle comprising a series of program steps is performed with and/or without the use of liquid. The wash liquid which is no longer required after performing a program step is pumped out of the dishwashing machine by means of a drain pump. For a subsequent program step, fresh water is then conducted into the dishwashing machine.

In order to reduce the water consumption during the wash cycle, it is known to detect the degree of contamination of the wash liquid used by means of an aqua sensor. Depending on the degree of contamination, after completion of the respective program step a partial pumping-out is performed in which the wash liquid is only partially discharged from the dishwashing machine and the remaining portion is reused in the next program step.

However, the use of such an aqua sensor is complex in terms of assembly and installation and is associated with production costs.

WO 2005/089621 A1 discloses a dishwashing machine in which exception conditions during the washing operation are detected by monitoring the current consumption of the circulation pump. Such exception conditions are, for example, clogging of the filter or blocking of the pump impeller of the circulation pump. Upon such an exception condition being detected, the rotational speed or the rotational direction of the circulation pump is altered.

The object of the invention is to provide a method for operating a water-conducting household device by means of which the water consumption may be reduced in a simple manner.

The invention is based on a method for operating a water-conducting household device, in particular a dishwashing machine, in which the level of filter contamination of a filtration system connected in the hydraulic circuit of the household device is detected.

According to the characterizing part of claim 1, the wash liquid is only partially discharged out of the household device when a predetermined threshold level of filter contamination has been fallen below. If the detected level of filter contamination falls below a predetermined threshold level of filter contamination, partial pumping-out takes place in which, after completion of a program step using liquid, the wash liquid is not entirely pumped out but only a portion of the wash liquid is pumped out. The portion of wash liquid remaining in the household device may be reused in following program steps using liquid, as a result of which the amount of fresh water supplied may be reduced.

In a development, the portion of wash liquid remaining in the water-conducting household device after partial pumping-out is applied to items to be cleaned. In the case of a dishwashing machine, the level of filter contamination may be detected, for example, during a pre-wash step. With only a low level of filter contamination, i.e. with only slightly contaminated wash liquid, the wash liquid used during the pre-wash step can therefore be at least partially reused in the subsequent cleaning step, and thus the overall water consumption reduced.

Moreover, it is provided in a development that in a filling step an additional quantity of water is added to the portion of wash liquid remaining in the water-conducting household device. In other words, by means of a filling step, the wash liquid in the water-conducting household device is sufficiently increased that, for example, a minimum level is reached for the operation of the water-conducting household device.

In a development, the level of filter contamination of the filtration system may be detected by means of a sensor device. To this end, suitable sensors, for example ultrasound sensors, may be used in order to detect, for example, filter cake formation. Alternatively, the sensor device may be embodied for detecting the rotational speed and/or power consumption of a motor which drives a circulation pump connected in the hydraulic circuit. In this case, variables such as for example control variables of a motor current controller and/or the frequency of an electronic commutation may be detected.

In a development, it is provided that for determining the level of filter contamination the rotational speed and/or power consumption of a circulation pump connected in the hydraulic circuit are detected. From a deviation of the detected rotational speed and/or power consumption from a predetermined characteristic, it is then possible to draw conclusions about the level of filter contamination of the filtration system in a simple manner.

In a further development, it is provided that for determining the level of filter contamination at least one rotational speed profile of the circulation pump is evaluated. With a high level of filter contamination, namely, air is drawn in by the circulation pump and/or the circulation pump rotates partially in idling mode. The rotational speed fluctuation of the circulation pump is therefore correspondingly high. In contrast thereto, with a reduced level of filter contamination, the rotational speed fluctuation is minimal, since no air is drawn in by the circulation pump and said circulation pump operates in normal circulating operation.

In a development, it is provided that a measure for rotational speed fluctuations of the circulation pump is determined from the rotational speed profile. Moreover, in a development it is provided that the measure for rotational speed fluctuations which has been determined is compared with at least one predetermined threshold value, and it is concluded that the predetermined threshold level of filter contamination has been undershot if the value of the determined measure for rotational speed fluctuations is lower than the predetermined threshold value.

In contrast to the prior art, therefore, the detection of the rotational speed in the circulation pump is not used for signaling exception conditions. Instead, the detected rotational speed of the circulation pump provides the basis of a decision as to whether partial pumping-out should take place or not when the liquid is changed.

In a development, it is provided that the circulation pump is driven by means of a brushless DC motor. For example, an asynchronous motor or a synchronous motor may be used as the drive motor for the circulation pump. Preferably, however, a synchronous motor is used. Such a motor permits in a comparatively simple manner a detection of the rotational speed thereof solely by monitoring the time characteristic of the electromotive force in the windings of the motor, i.e. the currents and/or voltages present at the motor, so that costly sensors which take up a lot of space on the motor and/or the pump are not required for determining the rotational speed. In contrast thereto, when using an asynchronous motor a rotational speed sensor is required for detecting the rotational speed fluctuation.

Further preferably, a brushless DC motor, i.e. a so-called BLDC motor may be used, in which the induced voltage (back electromotive force) is used for detecting the pump rotational speed and/or for detecting the rotor position without separate sensors having to be provided. Alternatively, for detecting the back electromotive force of the BLDC motor, the rotational speed of the circulation pump may also be detected on the basis of the phase shift of the force of the motor current applied to the pump motor.

The object of the invention is further achieved by means of a water-conducting household device, in particular a dishwashing machine, at least comprising a hydraulic circuit with a filtration system, the level of filter contamination thereof being detectable, and wash liquid being able to be discharged from the water-conducting household device, wherein according to the invention the wash liquid can be only partially discharged from the household device when a predetermined threshold level of filter contamination has been undershot.

Developments of the invention are set forth in the dependent claims.

An exemplary embodiment of the invention is described below with reference to the attached figures, in which:

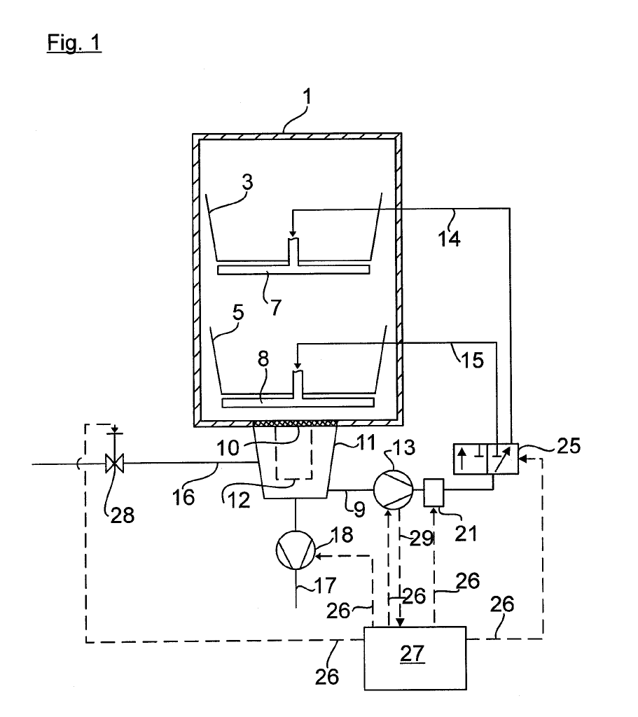

FIG. 1 shows a basic schematic view of an exemplary embodiment of a dishwashing machine for performing the washing method according to the invention; and

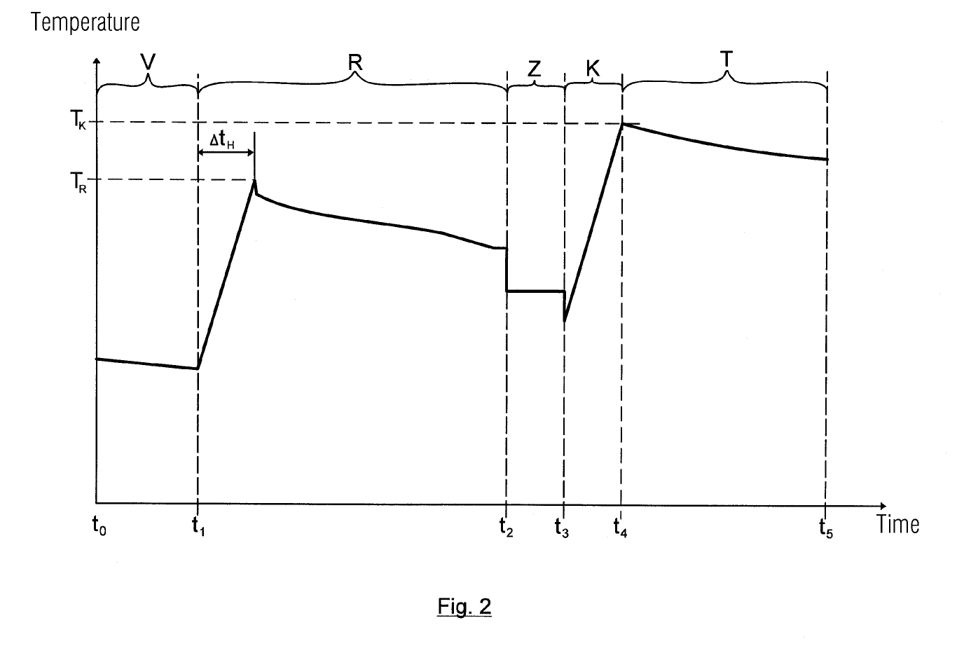

FIG. 2 shows a temperature-time diagram for illustrating the program steps performed in a wash cycle.

Reference is firstly made to FIG. 1.

As an exemplary embodiment for a water-conducting household device, a dishwashing machine is shown schematically in FIG. 1 with a dishwasher cavity 1 delimiting a dishwasher interior. Items to be cleaned (not shown) may be arranged in crockery baskets 3, 5 in the dishwasher interior of the dishwasher cavity 1. By way of example, two spray arms 7, 8 provided in different spray planes are arranged in the dishwasher cavity 1 shown, the items to be cleaned being impinged upon by wash liquid via said spray arms. In the dishwasher cavity base, a sump 11 with a filtration system indicated only roughly is provided in a known manner, which filtration system is formed from a planar fine filter 10 and a hollow cylindrical coarse filter 12. A circulating line 9 with a circulation pump arranged therein leads away from the sump 11. The circulating line 9 is connected to the spray arms 7, 8 via supply lines 14, 15 and via a water diverter 25 connected therein. A heating element 21 is connected downstream of the circulation pump 13 as a water heater.

Also connected to the sump 11 are a fresh water supply line 16 and a drain line 17 in which a drain pump 18 is arranged for pumping out wash liquid from the dishwasher cavity.

Now reference is also made to FIG. 2.

In FIG. 2, a wash program sequence of the dishwashing machine is shown with reference to a temperature-time diagram. The program sequence has individual subprogram steps with and/or without the use of liquid, namely pre-wash V, clean R, intermediate wash Z, rinse K, and dry T. The subprogram steps of the wash cycle are performed by means of a control device 27 by corresponding activation of the respective device components, namely the drain pump 18 or the circulation pump 13. The temperature-time profile relates to a mixing temperature in the dishwasher interior, which is present in the items to be washed, in the dishwasher cavity and possibly in the wash liquid.

The control device 27 is connected via signal lines 26 to the circulation pump 13 as well as the drain pump 18 and other device components of the hydraulic circuit in order to permit the transmission of signals.

Hereinafter, the wash cycle of the dishwashing machine is described with reference to the temperature-time profile of FIG. 2 insofar as this is necessary for understanding the invention.

After the start of the wash cycle at time tₒ, the pre-wash step V is performed in which the control device 27 opens the water inlet valve 28 in the fresh water supply line 16, causing fresh water to enter the sump 11. After completion of the pre-wash step V, i.e. at time t₁, the wash liquid is pumped out by means of the drain pump 18.

According to the invention, during the pre-wash step V, the rotational speed of the circulation pump 13 is detected and forwarded via a signal line 29 to the control device 27. The control device 27 has an evaluation unit which determines the level of filter contamination of the filtration system 10, 12 from a deviation of the detected actual rotational speed from a predetermined characteristic. In particular, in this case the rotational speed fluctuation of the circulation pump 13 during the pre-wash step V is detected and compared with a predetermined rotational speed fluctuation. This is based on the recognition that with a high level of filter contamination, the circulation pump 13 partially runs in idling mode and/or draws in air, as a result of which correspondingly great rotational speed fluctuations occur. In contrast, with a low level of filter contamination, the circulation pump runs continuously without major rotational speed fluctuations.

If, during the pre-wash step V, the evaluation unit of the control device 27 determines a merely reduced actual level of filter contamination of the filtration system, i.e. if the actual level of filter contamination falls below a predetermined threshold level of filter contamination, the control device 27 activates the drain pump 18 after completion of the pre-wash step V such that only a partial pumping-out of the wash liquid used takes place. The portion of wash liquid which remains in the hydraulic circuit of the dishwashing machine and which has not been pumped out is then reused in the subsequent cleaning step R. Accordingly, only a reduced quantity of fresh water is required for the cleaning step R, said fresh water being replenished, for example, in a replenishing step.

After the cleaning step R, an intermediate wash step Z, a rinse step K and a drying step T follow in a known manner.

In the present exemplary embodiment, a brushless DC motor with electronic commutation, i.e. a so-called BLDC motor, is used as a drive motor for the circulation pump 13. When a BLDC motor is used, the back electromotive force or back EMF is used for detecting the rotational speed and/or for detecting the position of the rotor, in which case the rotational speed may be detected in a simple manner without using additional sensors. In contrast thereto, when an asynchronous motor is used, an additional rotational speed sensor, for example a Hall sensor, is required.

### LIST OF REFERENCE NUMERALS

1 Dishwasher cavity
3, 5 Crockery baskets
7, 8 Spray arms
10 Fine filter
11 Sump
12 Hollow cylindrical coarse filter
13 Circulation pump
14, 15 Liquid lines
16 Fresh water supply line
17 Drain line
18 Drain pump
21 Heating element
25 Water diverter
26 Signal lines
27 Control device
28 Water inlet valve
29 Signal line
V, R, Z, K, T Program steps

1-20. (canceled)

21. A method for operating a water-conducting household device, comprising:
determining a level of filter contamination of a filtration system connected in a hydraulic circuit of the household device; and
partially discharging wash liquid out of the household device in response to a determination that a predetermined threshold level of filter contamination has been undershot.

22. The method of claim 21 for operating a dishwashing machine.

23. The method of claim 21, wherein a portion of the wash liquid remaining in the water-conducting household device after partial discharge is applied to the items to be cleaned.

24. The method of claim 23, wherein in a filling step an additional quantity of water is added to the portion of the wash liquid remaining in the water-conducting household device.

25. The method of claim 21, wherein the level of filter contamination of the filtration system is detected by means of a sensor device.

26. The method of claim 21, wherein the step of determining the level of filter contamination includes detecting at least one parameter selected from the group consisting of rotational speed and power consumption of a circulation pump connected in the hydraulic circuit.

27. The method of claim 26, wherein the step of determining the level of filter contamination includes evaluating at least a rotational speed profile of the circulation pump.

28. The method of claim 27, wherein a measure for rotational speed fluctuations of the circulation pump is determined from the rotational speed profile.

29. The method of claim 28, wherein the measure for rotational speed fluctuations is compared with at least one predetermined threshold value, and it is concluded that the predetermined threshold level of filter contamination has been undershot when the value of the determined measure for rotational speed fluctuations is lower than the predetermined threshold value.

30. The method of claim 21, further comprising driving a circulation pump by a brushless DC motor for applying wash liquid to items to be cleaned.

31. The method of claim 30, further comprising detecting an induced back electromotive force and/or a phase shift between an electrical voltage applied to the DC motor and a motor current for determining the rotational speed of the brushless DC motor.

32. A water-conducting household device, comprising a hydraulic circuit with a filtration system whose level of filter contamination is detectable, wherein wash liquid is dischargeable only partially from the household device when it is detected that the predetermined threshold level of filter contamination has been undershot.

33. The water-conducting household device of claim 32, constructed in the form of a dishwashing machine.

34. The water-conducting household device of claim 32, wherein a portion of wash liquid remaining in the water-conducting household device after partial pumping-out is applicable to items to be cleaned.

35. The water-conducting household device of claim 34, wherein in a filling step an additional quantity of water is added to the portion of wash liquid remaining in the water-conducting household device.

36. The water-conducting household device of claim 32, further comprising a sensor device constructed to detect the level of filter contamination of the filtration system.

37. The water-conducting household device of claim 36, further comprising a circulation pump connected in the hydraulic circuit, said sensor device detecting a rotational speed and/or power consumption of the circulation pump for determining the level of filter contamination.

38. The water-conducting household device of claim 37, further comprising a control device operably connected to the sensor device for evaluating at least one rotational speed profile of the circulation pump.

39. The water-conducting household device of claim 38, wherein the control device is embodied for determining a measure for rotational speed fluctuations of the circulation pump from the rotational speed profile.

40. The water-conducting household device of claim 39, wherein the control device is embodied for comparing the determined measure for rotational speed fluctuations with at least one predetermined threshold value and determining that the predetermined threshold level of filter contamination has been undershot when the value of the determined measure for rotational speed fluctuations is lower than the predetermined threshold value.

41. The water-conducting household device of claim 37, further comprising a brushless DC motor for driving the circulation pump.

42. The water-conducting household device of claim 41, further comprising a control device constructed to detect an induced back electromotive force and/or a phase shift between an electrical voltage applied to the DC motor and a motor current for determining the rotational speed of the brushless DC motor.
